(19) United States
(12) Patent Application Publication
(10) Pub. No.: US 2017/0013983 A1
(43) Pub. Date: Jan. 19, 2017

(54) Combined Wine Glass and Cork Remover Tool

(71) Applicant: Randolph Barry, Lancaster, MA (US)

(72) Inventor: Randolph Barry, Lancaster, MA (US)

(21) Appl. No.: 14/801,840

(22) Filed: Jul. 17, 2015

(51) Int. Cl. A47G 19/22; B67B 7/04

(52) U.S. Cl. CPC A47G 19/2255; B67B 7/0411

(57) ABSTRACT

A combined function wine glass and cork remover tool comprising of two pieces that fit together. A concave vessel attached to a hollow stem with one open end. A base with built in corkscrew and at least one circular ring seal. The base fits into the open ended-hollow stem encasing the corkscrew within the combined function cup. Base provides function of handle to provide leverage to remove cork and to provide stand for cup.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Cork wood and other composite materials are used to make cork that seals wine bottles in order to preserve wine. Wine requires a special shaped glass with components to enhance aroma, color, viscosity and flavor. Prior art requires two or more separate pieces to first open a bottle of wine, and second, a special wine glass to contain the wine. This invention provides one single solution to these problems in one low cost, light-weight, convenient, compound tool, a combination cup with a built in corkscrew type tool configured to be carried safely together with the corkscrew portion sheathed in the hollow stem portion of the combination cup with a built in corkscrew type tool.

The combination cup with a built in corkscrew type tool pertains to a combined apparatus that extracts corks from wine bottles and also serves as a drinking vessel when the apparatus is put together as one unit. This combination cup with a built in corkscrew type tool is adapted such that a corkscrew is contained within a hollow stem portion. This combination cup with a built in corkscrew type tool is comprised of two portions; a corkscrew centrally mounted in the circular base portion, and a tulip shape drink receptacle attached to a hollow stem to which the corkscrew centrally attached to a base portion slides into to keep the corkscrew safely sheathed inside the hollow stem portion. The corkscrew centrally attached to a base can easily be removed from the tulip shape drink receptacle attached to a hollow stem with a hollow cavity to extract a cork. The corkscrew base is then inserted back into the tulip shape drink receptacle attached to a hollow stem's open end and held secure by means of at least one circular ring seal set into the corkscrew centrally attached to a base, thus providing a sturdy single combination cup with a built in corkscrew type tool to pour the wine into, while keeping the corkscrew safely sheathed in the hollow stem portion of the tulip shape drink receptacle.

Prior art arrangements fail to simplify and make convenient the procedure of opening and drinking wine out of a wine glass forcing consumers to bring two bulky expensive items anywhere they want to enjoy a glass of wine. Prior art arrangements also fail to provide a place to safely keep the corkscrew contained within a vessel used to drink wine. This invention's precise combination tool structure allows consumers to open and contain wine for consumption with one tool at a picnic, RV, hotel or while camping for example. Furthermore, prior art fails to serve the space saving economic advantages of a combination cup with a built in corkscrew type tool.

### BRIEF SUMMARY OF THE INVENTION

The present invention pertains to the combined cup with a built in corkscrew type tool that allows consumers to open and enjoy wine with one compact tool. The tulip shape drink receptacle attached to a hollow stem portion encases the corkscrew centrally attached to a base portion. The corkscrew centrally attached to the base portion, slides into the open-end of the tulip shape drink receptacle attached to a hollow stem's hollow cavity. The corkscrew centrally attached to the base portion of the combination cup with a built in corkscrew type tool stays stable by means of at least one circular ring seal, keeping the corkscrew safely sheathed inside the hollow stem and ready for use at any time.

This invention provides a new and improved combination tool comprising a combination cup with a built in corkscrew type tool. This invention provides a high degree of utility and flexibility without having to purchase and maintain multiple separate tools. Furthermore, since only one tool is required, the all-over expense of purchasing a single tool rather than multiple separate tools is much lower. Not only does this invention open a bottle of wine, it also stores the corkscrew safely in the hollow stem of the tulip shape drink receptacle portion when not actively using the corkscrew to extract a cork from a bottle of wine.

### BRIEF DESCRIPTION OF THE SEVERAL VIEWS OF THE DRAWING

FIG. 1A Is a side view of the invention from which the present invention is assembled.

FIG. 1B Illustrates the corkscrew centrally attached to a base portion of the invention.

FIG. 1C Illustrates the tulip shape drink receptacle attached to a hollow stem with a hollow cavity portion of the invention.

### DETAILED DESCRIPTION OF THE INVENTION

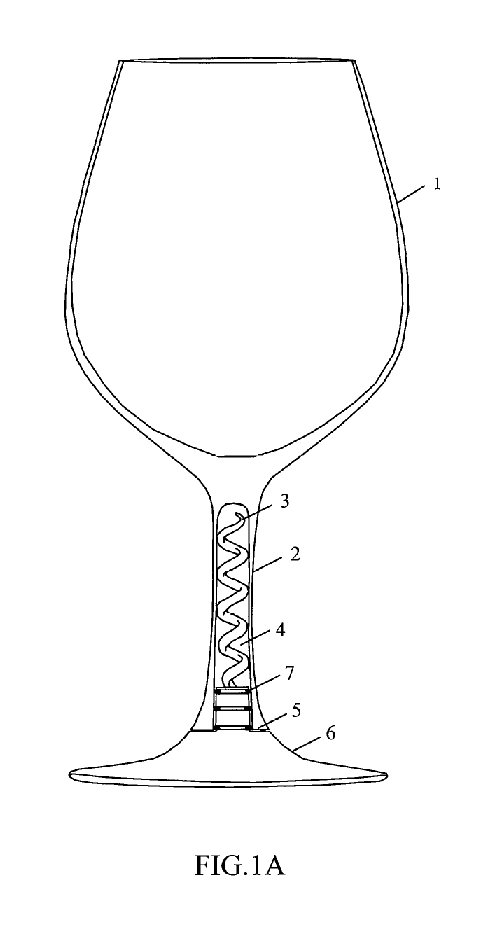

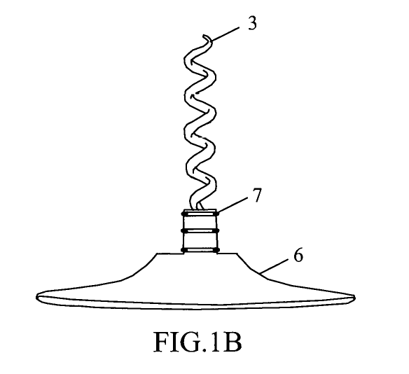

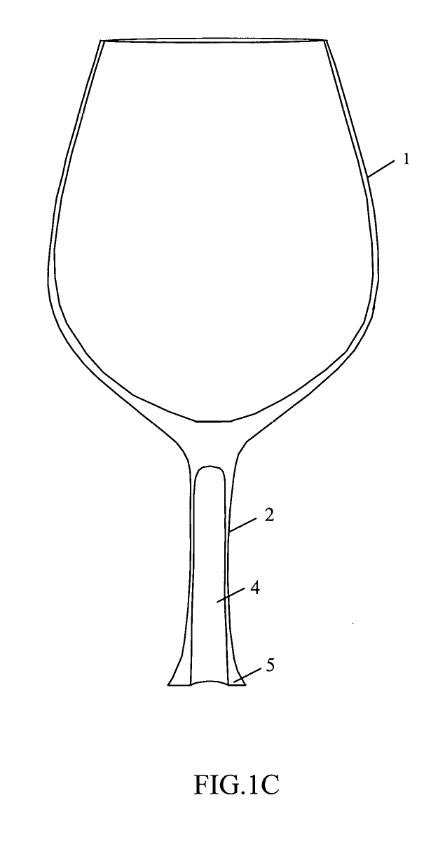

FIG. 1A is a side view of the combination cup with a built in corkscrew type tool invention. The invention has a tulip shape drink receptacle 1 attached to a hollow stem 2 which serves to sheath the corkscrew 3 in a hollow cavity 4 containing one open-end 5 opposite of the tulip shape drink receptacle 1. The base 6 of the combination cup with a built in corkscrew type tool contains a corkscrew 3 mounted in the center of the base 6 and includes at least one circular seal 7 to fit securely into the inside diameter of the hollow stem 2 that encases the corkscrew 3 in the hollow cavity 4; the corkscrew 3 centrally attached to the base 6 serves as a handle to the corkscrew 3 which functions to provide leverage to remove a cork from a bottle. The corkscrew centrally attached to the base 6, slides into the open-end 5 of the hollow cavity 4 of the hollow stem 2 to provide a base 6 for the tulip shape drink receptacle 1 attached to a hollow stem 2 portion of the combination cup with a built in corkscrew type tool.

FIG. 1B Illustrates the corkscrew 3 centrally attached to the base 6 portion of the invention and is a side view of the corkscrew 3 and base 6. The base 6 containing a centrally attached corkscrew 3 serves as a handle to the corkscrew 3 which functions to provide leverage to remove a cork from a bottle. At least one circular seal 7 securely joins the corkscrew 3 centrally attached to the base 6 to the tulip shape drink receptacle attached to a hollow stem in FIG. 1C. The base 6 functions to hold the tulip shape drink receptacle attached to a hollow stem portion in FIG. 1.C in an upright position.

FIG. 1C Illustrates the tulip shape drink receptacle 1 attached to a hollow stem 2 and hollow cavity 4 of the hollow stem 2 portion of the invention and is a side view of the tulip shaped drink receptacle 1 attached to a hollow stem 2 and a hollow cavity 4 of the hollow stem 2 with an open-end 5 opposite of the tulip shape drink receptacle 1 which serves to encase the corkscrew and base as described in FIG. 1B.

1. A combination cup with a built in corkscrew type tool comprising:
two separate portions that join together;
a tulip shape drink receptacle attached to a hollow stem with a hollow cavity portion;
a corkscrew centrally attached to a base portion;
the tulip shape drink receptacle attached to the hollow stem with the hollow cavity portion sheathing the corkscrew centrally attached to the base; the corkscrew centrally attached to the base portion functioning as both a base to the tulip shaped drink receptacle attached to the hollow stem with the hollow cavity portion, when joined together, and as a handle to the corkscrew to remove a cork when separated from the tulip shape drink receptacle attached to the hollow stem with the hollow cavity portion.

2. The combination cup with a built in corkscrew type tool in accordance with claim 1 wherein:
the corkscrew centrally attached to the base portion having a base that is circular and attached to the hollow stem with the hollow cavity and configured to fit the corkscrew securely inside of the tulip shaped drink receptacle attached to the hollow stem with the hollow cavity portion by means of friction provided by at least one circular ring seal, just slightly larger than an inside diameter of the hollow stem portion; and the friction of the circular ring secures the corkscrew safely in the hallow stem, and when the corkscrew centrally attached to the base is extracted from the tulip shape drink receptacle attached to the hollow stem with the hollow cavity portion, the corkscrew is configured to be used as a tool to remove corks from bottles.

3. The combination cup with a built in corkscrew type tool in accordance with claim 1 wherein:
the corkscrew centrally attached to the base portion functions to extract corks from wine bottles by removing the corkscrew centrally attached to the base portion from the tulip shape drink receptacle attached to the hollow stem with a hollow cavity portion, inserting and applying force to the corkscrew centrally attached to the base portion into a cork until the cork is removed, and the corkscrew centrally attached to the base functions to hold the tulip shape drink receptacle attached to the hollow stem with the hollow cavity portion in an upright position.
